(19) United States
(12) Patent Application Publication
(10) Pub. No.: US 2009/0063276 A1
(43) Pub. Date: Mar. 5, 2009

(54) Deferred Performance Based Advertising and reward Payment Process

(76) Inventor: Chinedu U. Ekechukwu, Centreville, VA (US)

Correspondence Address: WHITE-WELKER & WELKER, LLC, P.O. BOX 199, CLEAR SPRING, MD, 21722-0199, US

(21) Appl. No.: 12/197,402

(22) Filed: Aug. 25, 2008

Related U.S. Application Data
(60) Provisional application No. 60/968,341, filed on Aug. 28, 2007.

(51) Int. Cl. G06Q 30/00

(52) U.S. Cl. 705/14

(57) ABSTRACT

A marketplace service platform (“service provider”) that allows for deferred payment of advertising or promotional fees by an offerer (“offerer”) until after the sale, lease, or execution of the product or service whereby the service provider then shares a predetermined portion of the payment with the customer, lessee, or service recipient. The returned portion of the fee to the customer may be deemed as a “reward” for having used the service provider to locate and execute a transaction. The offerer indicates the amount of the reward the service provider must offer to the customer prior to any interaction between the offerer and customer.

### CROSS REFERENCE TO RELATED APPLICATIONS

This application claims priority from U.S. Provisional Patent Application Ser. No. 60/968,341, entitled “Deferred Performance Based Advertising and reward Payment Process”, filed on 28 Aug. 2007. The benefit under 35 USC § 119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to an electronic advertising payment process. More specifically, the present invention relates to a deferred performance based advertising and reward payment process for within marketplace service platform (“service provider”) that allows for postponed payment of advertising or promotional fees by an offerer (“offerer”) until after the sale, lease, or execution of the product or service whereby the service provider then shares a predetermined portion of the payment with the customer, lessee, or service recipient (“customer”).

### BACKGROUND OF THE INVENTION

It can be appreciated that electronic advertising payments have been in use for years. Select real estate brokerage firms offer up to 2% rebate upon closing to clients such as RebateReps.com, HomeGain.com, or ZipRealty.com. Similarly, apartment Internet listing services (ILS) such as Rent.com that offer $100 cash back upon lease signing.

The main problem with conventional electronic advertising payment processes as related to home purchases, similar systems require a potential homebuyer to utilize a designated real estate broker in order to receive a rebate or incentive; of particular note is the patent “System and Method for Directing and Instructing customers to Deal with Specific Merchants Using Incentives” (patent number: U.S. Pat. No. 6,578,011). However, this model eliminates such restrictions.

Secondly, another problem with conventional electronic advertising payment processes is that some state agencies prohibit third parties (i.e., Internet listing services) from receiving payment from a real estate brokers for directing customers to them (i.e., finders' fees). However, no such restrictions exist regarding general advertisement payments made by real estate brokers to third parties (i.e., newspapers, magazines, online home advertising websites, etc.) for marketing purposes.

Lastly, another problem with conventional electronic advertising payment processes is no other ones allow the property advertiser to select the amount the ILS will offer as a reward to the prospective tenant/homebuyer.

While these processes may be suitable for the particular purpose to which they address, they are not as suitable for a generalized marketplace service platform that allows for deferred payment of advertising or promotional fees by an offerer until after the sale, lease, or execution of the product or service whereby the service provider then shares a predetermined portion of the payment with the customer, lessee, or service recipient.

In these respects, the deferred performance based advertising and reward payment according to the present invention substantially departs from the conventional concepts and designs of the prior art, and in so doing provide an apparatus primarily developed for the purpose of herein described.

### SUMMARY OF THE INVENTION

The present invention provides a new deferred performance based advertising and reward payment construction wherein the same can be utilized for a marketplace service platform (“service provider”) that allows for deferred payment of advertising or promotional fees by an offerer (“offerer”) until after the sale, lease, or execution of the product or service whereby the service provider then shares a predetermined portion of the payment with the customer, lessee, or service recipient (“customer”).

The general purpose of the present invention, which will be described subsequently in greater detail, is to provide a new deferred performance based advertising and reward payment that has many of the advantages of the electronic advertising payment mentioned heretofore and many novel features that result in a new deferred performance based advertising and reward payment which is not anticipated, rendered obvious, suggested, or even implied by any of the prior art electronic advertising payment, either alone or in any combination thereof.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the Deferred Performance Based Advertising and reward Payment Process;

FIG. 2 illustrates an Example offerer promotional fee Set Up Form;

FIG. 3 illustrates an Example Listing Search and Results;

FIG. 4 illustrates an Example Listing Detail Screen; and

FIGS. 5-11 are wire frame drawings illustrating the customer's perspective of the transaction process of the present invention; and

FIGS. 12-16 are wire frame drawings illustrating the offerer's perspective of the transaction process of the present invention.

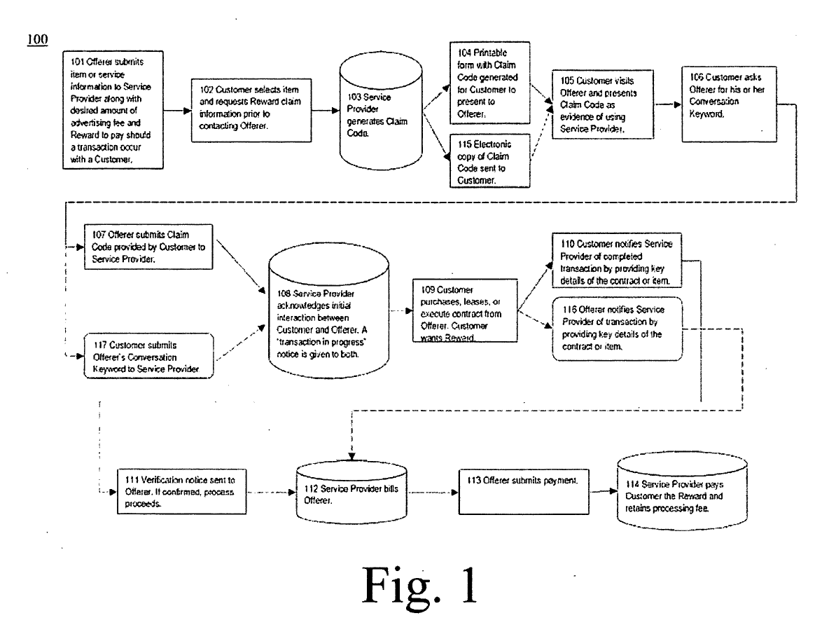

### DETAILED DESCRIPTION OF THE INVENTION

To attain this, the present invention generally permits a pay-for-performance advertising model that rewards users for utilizing a specific marketplace to conduct transactions. As incentives, rebates, and rewards prove useful in enticing potential customers to buy, lease, or utilize services of offerers, a service that incorporates these principals proves of great value to offerers and customers, alike. This process allows for the creation of a marketplace that connects customers and offerers through the use of rewards without the restrictions of similar methods. Moreover, when applied to real estate it possesses particularly unique benefits.

This process permits an individual selling or leasing an item of value (the “offerer”) to designate the amount to pay for the marketing and advertising assistance (referred to as the “promotional fee”) of a marketplace operator (commonly known and referred to as a “service provider”). When creating a listing advertisement, upon a successful completed transaction, the offerer may choose to pay the service provider a percentage of the sale, lease, or service price; a fixed rate; or nothing at all. The service provider induces users to utilize its marketplace over competitors by providing incentives (“rewards”) for any customer, lessee, or service recipient (“customer”) who successfully completes a transaction with a listed offerer.

When selecting the payment option, the offerer indicates the amount the service provider should tender as a reward. If the offerer elects to pay no transactional charge (also referred to as a “processing fee”) during the listing creation, then no reward will be offered to prospective customers. The reward amount is pegged to the promotional fee in some manner such as, but not limited to, the relationship of promotional fee=reward to customer+processing fee.

Upon a successful transaction, the offerer pays the service provider its promotional fee for advertising an item. If designated, the service provider pays the customer a reward and retains the processing fee as payment for their services.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The present invention provides a deferred performance based advertising and reward payment that will overcome the shortcomings of the prior art processes.

A marketplace service platform (“service provider”) that allows for deferred payment of advertising or promotional fees by an offerer (“offerer”) until after the sale, lease, or execution of the product or service whereby the service provider then shares a predetermined portion of the payment with the customer, lessee, or service recipient (“customer”).

A portion of the promotional fee from the offerer may be transferred to the customer as a “reward” for having used the service provider to locate and execute a transaction. The offerer indicates the amount of the reward the service provider must offer to the customer prior to any interaction between the offerer and customer.

For items that take the form of real estate, the prospective customer is not required to utilize any designated real estate broker in order to receive a rebate or incentive. Moreover, the prospective customer may obtain the services of any real estate agent, broker, or attorney; or may choose to represent him or herself in the transaction. Any fees paid to the service provider are for the marketing and/or promotion of real estate to the general public and should not be regarded as a finders or referral fee. A determination as such removes the obligation that the service provider maintain a real estate brokers license and enables the offerer to consider such fees as a tax deductible marketing expense should he or she be licensed as a real estate salesperson or broker.

The process does not limit items of trade to real estate, but may be used for any item or service for sale or lease.

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. Now referring to Figures, the embodiment of the deferred performance based advertising and reward payment process 100 is illustrated. Computer readable codes are stored on the computer readable medium and are readable by a computer to direct the computer to perform the steps of the method taught herein.

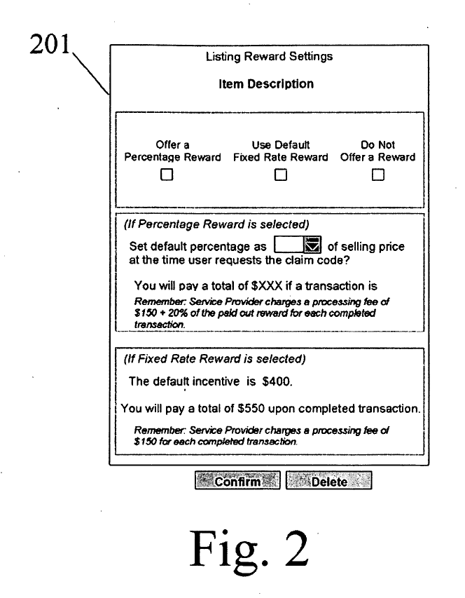

In a first step, 101, the offerer submits personally identifying information along with descriptions of the item or service to be promoted on the service provider's website. Additionally, the offerer selects how much to pay the service provider for its marketing and advertising services (“promotional fee”) should a transaction occur as a result with a customer who discovered the listing via the website. Two components comprise the promotional fee. One portion is offered to the customer by the service provider as a reward for their patronage. The other portion is retained by the service provider as a processing fee. Given the relationship that may exist of promotional fee=reward to customer+processing fee, the reward and/or processing fee may be a percentage of the item or service sale price, a fixed amount, or a combination of both. Similarly, the offerer may choose the promotional fee amount as a fixed value; based upon a percentage of the price of the item or service; or no charge. Should the offerer select not to pay a promotional fee, then no reward component shall be presented to the customer. See FIG. 2 for a visual example of the Listing reward Settings 201.

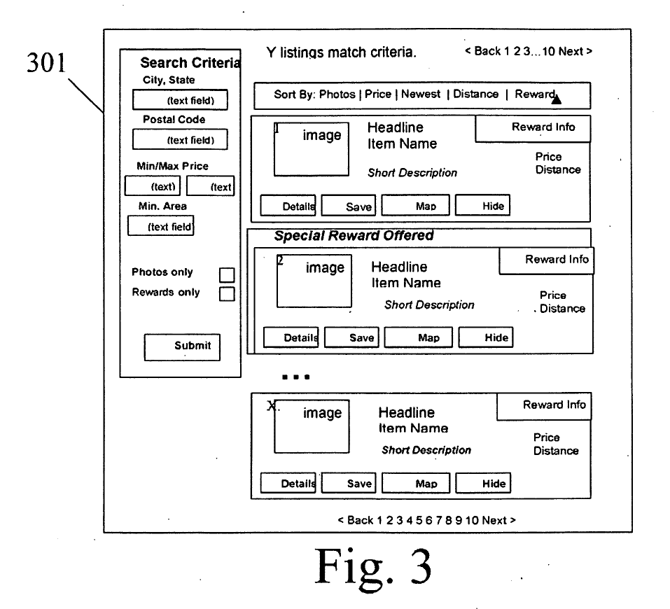

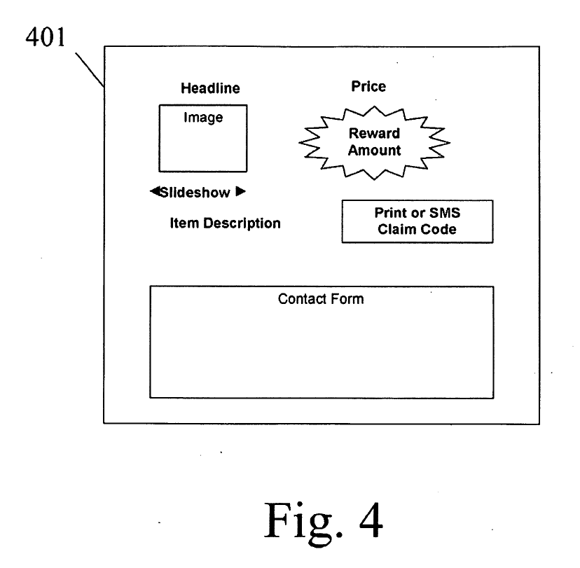

Next, the customer reviews numerous listings that match search criteria inputted by the customer in step 102. Labels indicating the reward amount, if any, accompany each listing. The customer may sort the listings to highlight those with the largest reward amount or eliminate those with no reward from appearing in the search results. See FIG. 3 for a visual example of a listing search and results 301. Once a favored listing is located, the customer may request reward claim information by pressing a button on the listing. See FIG. 4 for a visual example of a listing detail screen 401.

The system generates a unique, alphanumeric transaction identification number (“claim code”). Each claim code associates to the time of the request initiation, the value of the offered reward, the offerer who created the listing, and the customer in step 103. Since the cost of the item may change over time, the value of the reward presented to future customers may change if the offerer selected to peg the reward as a percentage of the price. The amount of the reward offered to a specific customer is that presented to the customer at the time of the claim code generation. In this given embodiment, should the offerer alter the reward amount to others, the original customer may only lay claim to the amount associated with the claim code.

This claim code may be printed from the service provider's website to serve as a reference of the customer's interest in the listing and reward, in step 104.

Alternatively in step 116, the claim code may be sent via an electronic method such as by short message service (SMS), e-mail, or stored with a user accessible location within the service provider' website.

The customer contacts the offerer to discuss interest in the listing. The customer presents the claim code to the offerer as evidence of having used the service provider's website, in step 105.

During this interaction, the customer must request a special secret word (“conversation keyword”) created by the offerer and also stored within the service provider's system. Knowledge of the conversation keyword serves as evidence of communication between the customer and the offerer in step 106. This conversation keyword is created by the offerer during initial registration with the service provider. All listings created by the offerer, should multiple ones exist, share the same conversation keyword. The offerer may change the conversation keyword at any time to reduce the likelihood of former customers falsely claiming interactions for other listings. As communications from prospective customers may arrive via offline sources where the offerer may not have access to electronic devices, the service provider's system does not generate the keyword. Since the conversation keyword is user-generated, the likelihood the offerer forgetting it is greatly reduced during these situations.

For the service provider to realize and acknowledge the occurrence of any offline or online interactions between the offerer and the customer, one or both parties must notify the service provider in step 107. The offerer may inform the service provider by submitting the claim code provided by the customer within a personalized user-accessible administrative area of the website.

Alternatively in step 117, the customer may submit the offerer's conversation keyword to the service provider as acknowledgement of an interaction.

The system confirms that the customer and offerer inputted a correct and valid conversation keyword and/or Confirmation Code, respectively in step 108. After validation, a notice appears in the personalized user-accessible administrative area of the service provider's website. The offerer may enter multiple Confirmation Codes given several potential customers may initiate communications. However, a customer may only enter one conversation keyword per listing. The system must ensure that while the public-facing item listing description information page may be deleted at any time by the offerer, records of the interactions must be maintained.

The customer completes a transaction by purchasing, leasing, or utilizing services from the offerer in step 109. The customer now desires to receive the promised reward from the service provider.

The customer accesses a portion of the service provider's website and provides key details of the transaction in step 110. Examples of details include, but not limited to: the final purchase price including taxes, levies, or fees; the name, address, and conversation keyword of the offerer; unit and street number of any property that may have been transacted; the serial, UPC code, or other identifying information relating to items; and the date of purchase, lease, or service initiation.

Alternatively in step 116, the offerer may notify the service provider by accessing its website and providing key details of the transaction similar to those in 110.

If the customer first notifies the service provider as in step 110, the system submits a verification notice to the offerer indicating the information provided by the customer in step 111.

The offerer possesses the option to confirm or deny the verification notice. If the offerer denies the notice, the customer may revise any errors or file a claim. Otherwise, the process proceeds.

In step 112, should the offerer confirm the verification notice or first notify the service provider of a completed transaction as in 116, the promotional fee is charged to the offerer's account.

In step 113, the offerer submits payment.

In step 114, the service provider pays the customer the reward as gratitude for patronage and retains the processing fee component.

In an alternative embodiment, this process may be shortened by eliminating steps 106 through 108, which eliminates the service provider's knowledge of an initial communication.

Thus the customer and offerer notify the service provider only upon the completion of a transaction. However, such an abbreviated process model may heighten the likelihood of fraud and nonpayment of funds by the offerer given and reduces the service provider's ability to monitor the overall number of leads directed to the offerer.

As to a further discussion of the manner of usage and operation of the present invention, the same should be apparent from the above description. Accordingly, no further discussion relating to the manner of usage and operation will be provided.

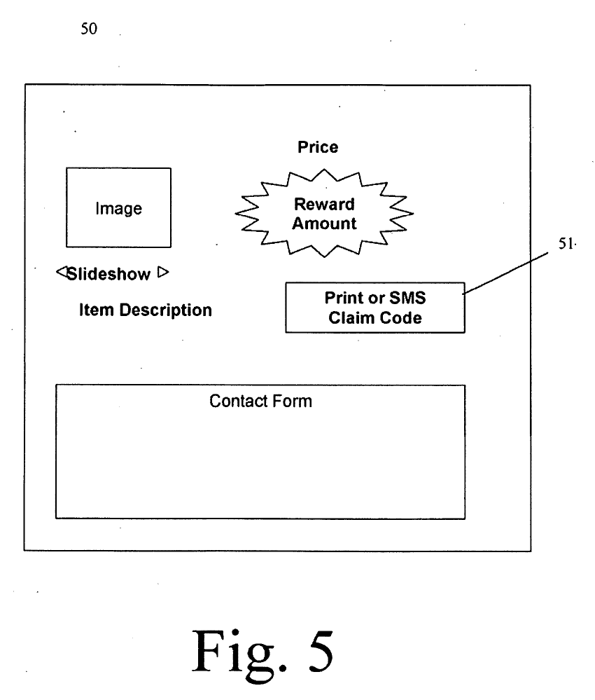

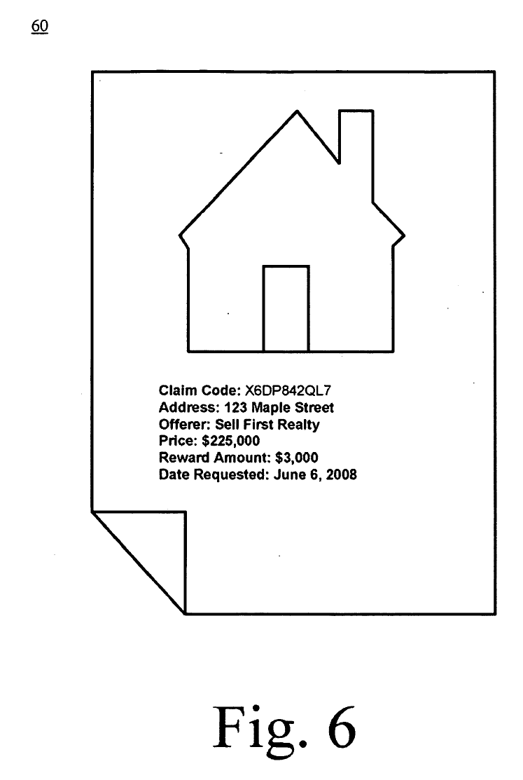

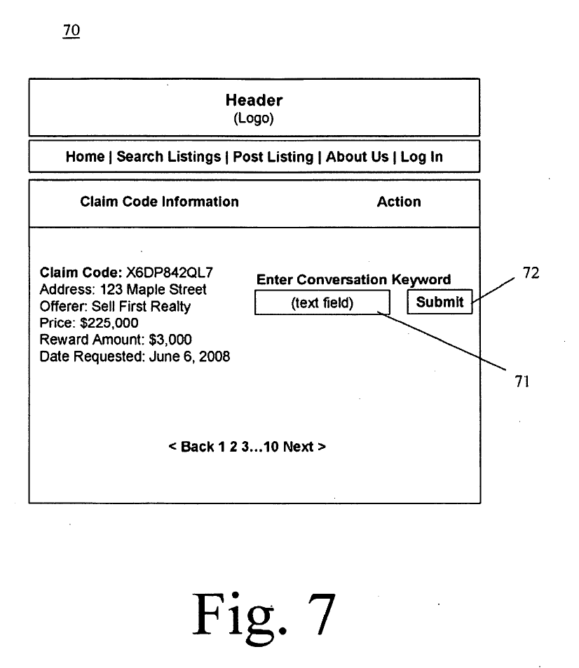

A representative transaction using the method of the present invention presented from the customer's point of view is now discussed and illustrated in FIG. 5 thru 11. First, the customer looking to purchase an item, property, or service will go to a listing detail page 50 as shown in FIG. 5, created by an offerer. Next, the customer desiring to purchase the item, property, or service selects a link 51 on the listing profile to obtain a claim code and print a receipt, FIG. 6, that may be presented to the offerer. Once the customer contacts the offerer, the customer proceeds to a personalized user-accessible administrative area 70 and enters the conversation keyword 71 provided to him or her by the offerer and selects a submit button 72 on the website 70 as shown in FIG. 7.

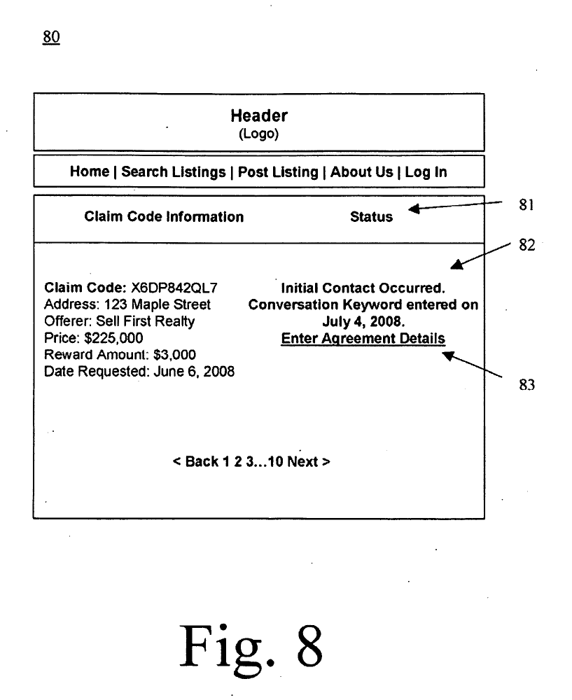

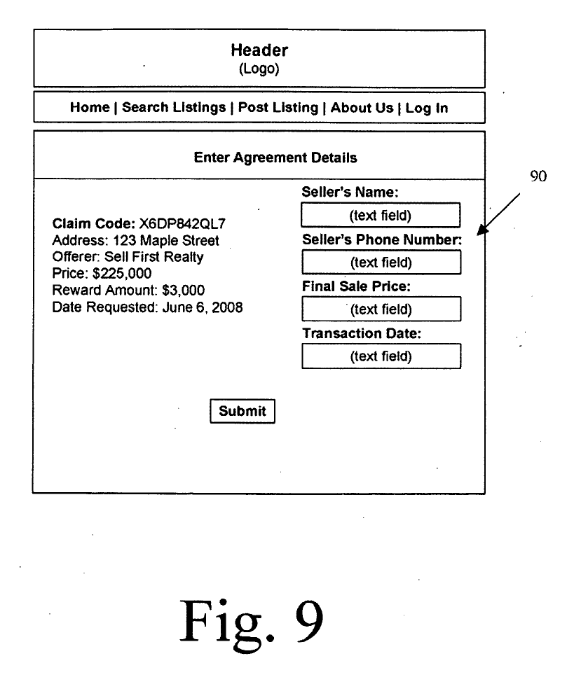

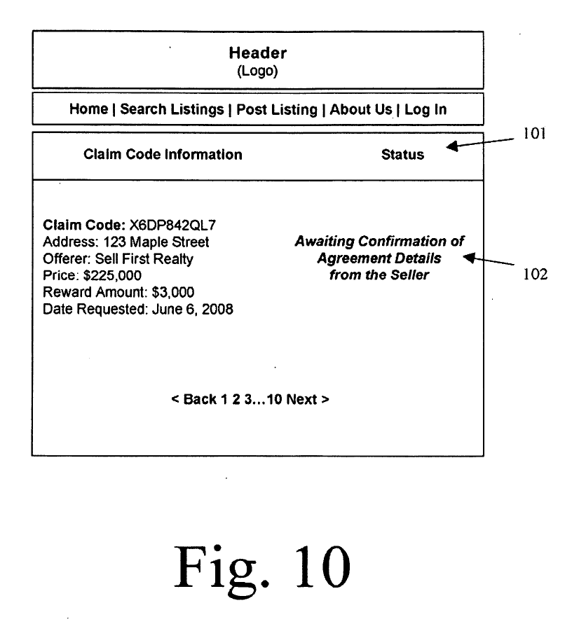

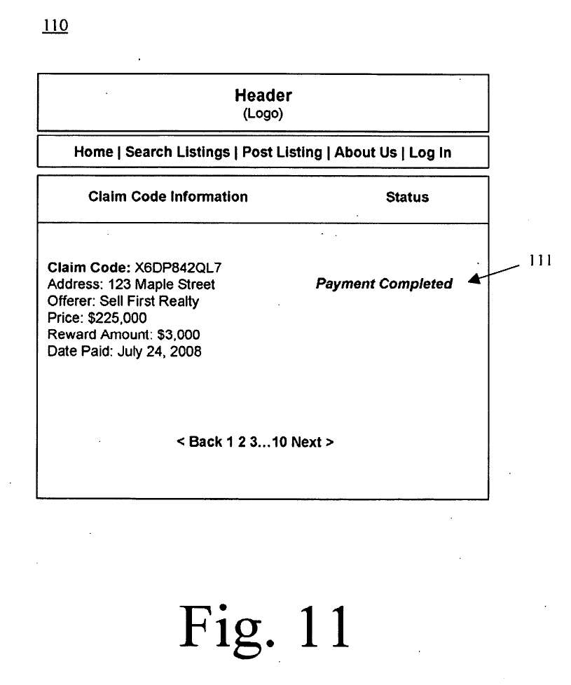

At this point the item status in the customer's personalized user-accessible administrative area 81 changes to indicate that some initial contact occurred 82 with a time and date stamp and a prompting to enter agreement details or other transaction information 83 as shown in FIG. 8. Next the customer initiates the process by entering agreement detail's or other transaction information and completing a form 90 for collecting the information as shown in FIG. 9. After submitting the additional information, the item status 101 will reflect that the agreement details and information have been received by the offerer and that customer is awaiting confirmation 102, as shown in FIG. 10. Upon approval of the terms by the offerer, the status of the item in the customer's display 110 as shown in FIG. 11 would reflect the processing of payment and/or payment completion 111.

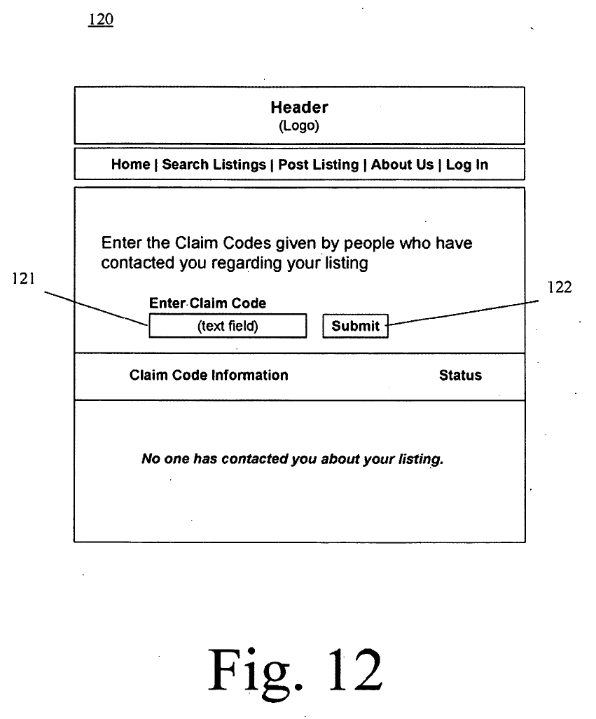

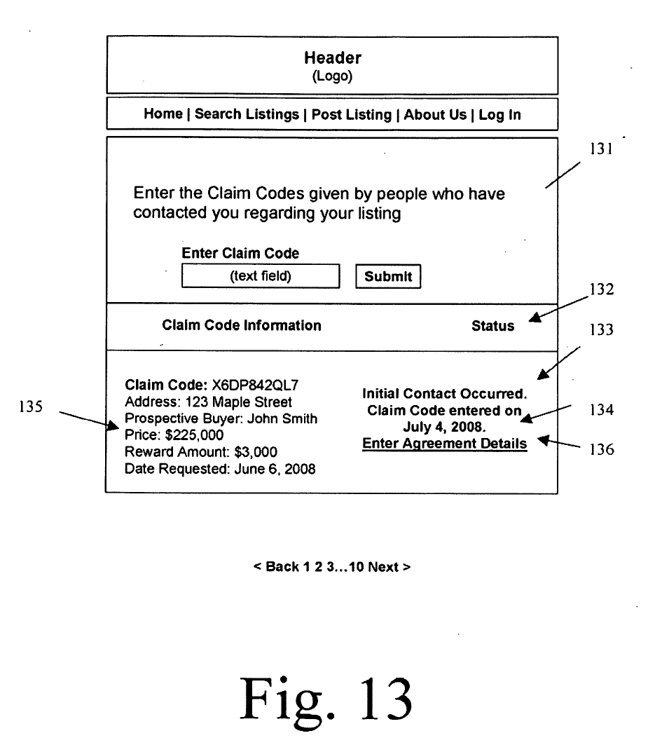

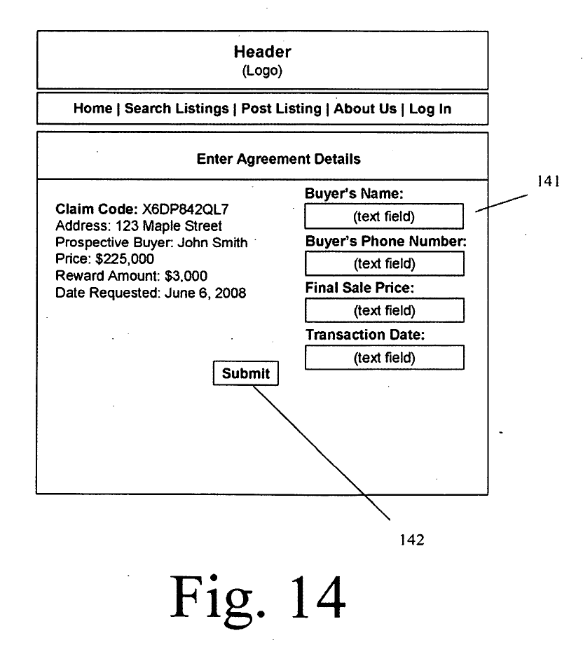

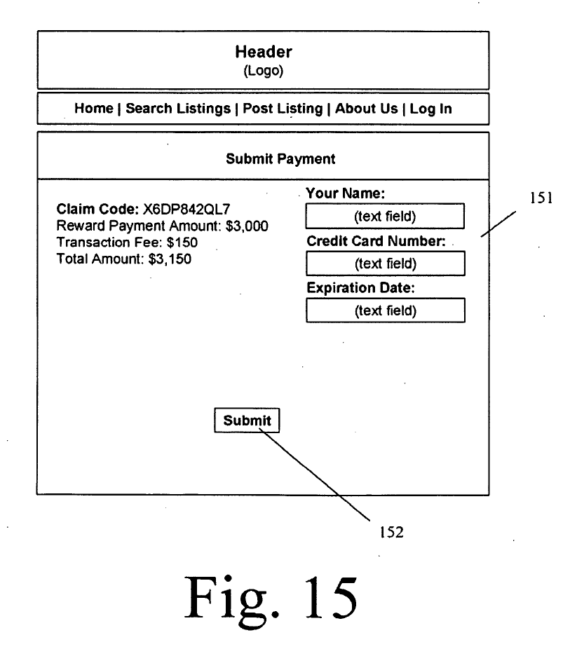

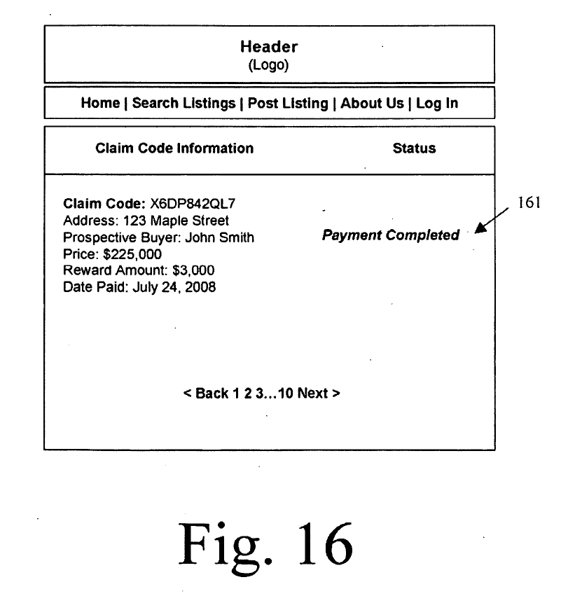

A representative transaction using the method of the present invention presented from the offerer's point of view is now discussed and illustrated in FIG. 12 thru 16. Once an offerer has created an item, property, or service description, and receives an inquiry from a prospective customer, the offerer enters a corresponding claim code 120 within his or her personalized user-accessible administrative area 120 and presses a form submission button 122 as shown in FIG. 12. After entering claim codes given to the offerer by customers 131 the item status 132 will reflect whether any initial contact that has occurred, a time and date stamp confirming the entry of any claim codes 134, claim code information 135, and a prompting for the offerer to enter agreement details or other transaction information 36 as shown in FIG. 13. Next the offerer enters the agreement details or other transaction information by selecting the link 136 and completing a form 141 and submitting the data 142 as shown in FIG. 14. After accepting a customer's offer and submitting the agreement details, the next step requires payment of the promotional fee to be submitted by the offerer as shown in FIG. 15. At this point the offerer enters payment details 151 and selects a link or button 152 to submit the payment details 151 as shown in FIG. 15. If the offerer successfully submits payment, then the transaction is competed as shown in FIG. 16 and the process ends or is repeated as necessary.

Furthermore, other areas of art may benefit from this method and adjustments to the design are anticipated. Thus, the scope of the invention should be determined by the appended claims and their legal equivalents, rather than by the examples given.

I claim:

1. A computer implemented method for deferred performance based advertising and reward payment through a service provider comprising the steps of:
a) accepting identifying information relating to a listing of an item or service to be promoted by a service provider's website from an offerer;
b) accepting the entry by the offerer of a promotional fee amount, to pay the service provider should a transaction occur between a customer and the offerer from the listing, the promotional fee comprising a reward amount and a processing fee;
c) if there is a reward amount for a listing, indicating the reward amount associated with the listing;
d) accepting a selection of a listing from the customer;
e) if there is a reward amount associated with the listing, generating a claim code for a reward claim;
f) receiving a notification providing information about the transaction after a transaction with a reward has been completed;
g) accepting payment by the offerer of the promotional fee; and
h) paying the customer the reward amount.

2. The method of claim 1, further comprising the step of:
i) providing a verification notice indicating receipt of information; and
j) accepting a confirmation from the offerer of completed transaction; if a customer provides details in step i.

3. The method of claim 1, further comprising the steps of:
k) accepting at least one search criteria from a customer; and
l) displaying at least one listing which matches the search criteria;

4. The method of claim 3, in which the listings in step k are sorted by reward amount.

5. The method of claim 3, in which the listings with no reward amount are not displayed in step k.

6. The method of claim 1, in which the reward amount is determined as a percentage of the reward component, a fixed amount, or a combination of both.

7. The method of claim 1, wherein in step b, the promotional fee amount is a fixed value; a percentage of the price of the item or service; or no charge.

8. The method of claim 1, in which the claim code generated in step e is associated with at least one of the following factors: the time of request initiation, the reward amount, the offerer who created the listing, and the customer.

9. The method of claim 1, wherein in step e, the claim code is sent via an electronic method such as by short message service (SMS), e-mail, or stored with a user accessible location within the service provider's website or simply viewed or printed.

10. The method of claim 8, further comprising the steps of:
m) receiving a conversation keyword or a claim code;
n) acknowledging the occurrence of an interactions between the offerer and the customer; and
o) validating conversation keyword or a claim code an interaction between the offerer and the customer.

11. The method of claim 10, wherein knowledge of the conversation keyword by the customer or knowledge of the claim code by the offerer, serves as evidence of communication between the customer and the offerer.

12. The method of claim 2, wherein in step i, the offerer confirms the transaction by providing key details of the transaction.

13. The method of claim 2, further comprising the step of:
p) receiving confirmation or denial of the verification notice provided in step i.
